(19) United States
(12) Patent Application Publication
(10) Pub. No.: US 2008/0241507 A1
(43) Pub. Date: Oct. 2, 2008

(54) CONDUCTIVE TAPE AND METHOD FOR MAKING THE SAME

(75) Inventors: WEI-QI FU, Beijing (CN); LIANG LIU, Beijing (CN); PENG LIU, Beijing (CN); YUAN-CHAO YANG, Beijing (CN); SHOU-SHAN FAN, Beijing (CN)

Correspondence Address: PCE INDUSTRY, INC.;ATT. CHENG-JU CHIANG, 458 E. LAMBERT ROAD, FULLERTON, CA, 92835, US

(73) Assignees: TSINGHUA UNIVERSITY, Beijing (CN); HON HAI PRECISION INDUSTRY CO., LTD., Tu-Cheng (TW)

(21) Appl. No.: 11/967,123

(22) Filed: Dec. 29, 2007

(30) Foreign Application Priority Data
Mar. 30, 2007 (CN) 200710073769.6

(51) Int. Cl. B32B 5/16; B05D 5/10

(52) U.S. Cl. 428/323; 427/207.1

(57) ABSTRACT

A conductive tape includes an adhesive layer and a base. The adhesive layer is formed on a surface of the base. The adhesive layer contains carbon nanoscale materials. A method for making the conductive tape includes the steps of: fabricating a carbon nanoscale material conductive solution and an adhesive agent; coating a mixture of the carbon nanoscale material conductive solution and the adhesive agent on the base; and drying the mixture on the base so as to form the conductive tape.

### RELATED APPLICATIONS

This application is related to common-assigned applications entitled, “CONDUCTIVE TAPE AND METHOD FOR MAKING THE SAME”, filed ______ (Atty. Docket No. US13914); “CONDUCTIVE TAPE AND METHOD FOR MAKING THE SAME”, filed ______ (Atty. Docket No. US13916). Disclosures of the above-identified applications are incorporated herein by reference.

### BACKGROUND

1. Field of the Invention

The invention generally relates to conductive tapes and methods for making the same, and, particularly, to a conductive tape including array of carbon nanotubes and a method for the same.

2. Discussion of Related Art

During scanning electron microscopy (SEM) and X-ray spectroscopy (EDS) analysis, a conductive adhesive material is usually needed to fix samples for observation. Currently, Carbon Conductive Tape (CCT) is widely used as the adhesive and conductive material. Further, the CCT includes amorphous carbon.

However, the CCT has the following drawbacks. Firstly, electrical resistance of the CCT is relatively large, generally about 700 K ohm/centimeter (KΩ/cm). Secondly, production cost of the CCT is relatively high.

What is needed, therefore, is a conductive tape, which has a low electrical resistance and good conductivity, and a method for making the same, which has low production cost.

### SUMMARY

A conductive tape includes an adhesive layer and a base. The adhesive layer is formed on a surface of the base. The adhesive layer contains carbon nanoscale materials. A method for making the conductive tape includes the steps of: fabricating a carbon nanoscale material conductive solution and an adhesive agent; coating a mixture of the carbon nanoscale material conductive solution and the adhesive agent on the base; and drying the mixture on the base so as to form the conductive tape.

Other advantages and novel features of the present conductive tape and method for making the same film will become more apparent from the following detailed description of present embodiments when taken in conjunction with the accompanying drawings.

### BRIEF DESCRIPTION OF THE DRAWINGS

Many aspects of the present conductive tape and method for making the same can be better understood with reference to the following drawings. The components in the drawings are not necessarily to scale, the emphasis instead being placed upon clearly illustrating the principles of the present conductive tape and method for making the same.

FIG. 1 shows a sectional and schematic view of a conductive tape in accordance with the present embodiment.

FIG. 2 is a flow chart of a method for making the conductive tape shown in FIG. 1.

Corresponding reference characters indicate corresponding parts throughout the several views. The exemplifications set out herein illustrate at least one present embodiment of the conductive tape and method for making the same, in at least one form, and such exemplifications are not to be construed as limiting the scope of the invention in any manner.

### DETAILED DESCRIPTION OF PREFERRED EMBODIMENTS

Reference will now be made to the drawings, in detail, to describe embodiments of the method for making the carbon nanotube film.

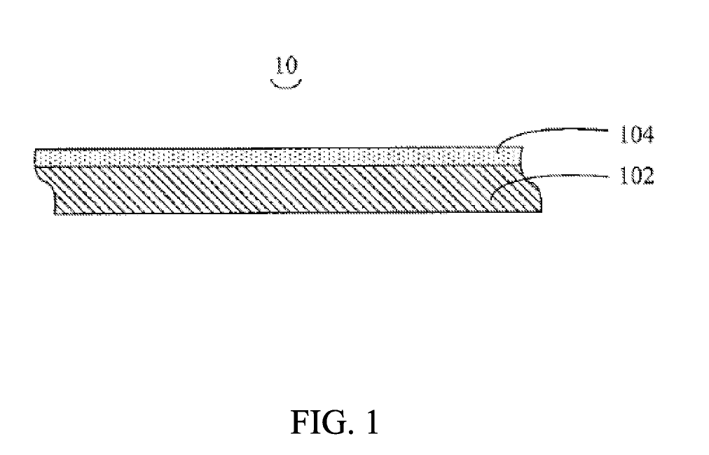

Referring to FIG. 1, a conductive tape 10 is provided in the present embodiment. The conductive tape 10 includes an adhesive layer 104 and a base 102. The adhesive layer 104 is formed on a surface of the base 102. The adhesive layer 104 contains carbon nanoscale materials. The base 102 is selected from the group consisting of polymer films having good tensile strength.

In the present embodiment, the adhesive layer 104 includes a pressure sensitive adhesive layer. The adhesive layer 104 contains a carbon nanoscale material and an adhesive agent. Further, the carbon nanoscale material is composed of nanoscale particles. The nanoscale particles include carbon nanotubes, carbon nanoscale spheres, and any combination thereof. The carbon nanotubes are selected from the group consisting of single-walled carbon nanotubes, and multi-walled carbon nanotubes. The array of carbon nanotubes is formed by one of a chemical vapor deposition method, an arc discharge method, and a laser evaporation method. It is to be noted that the carbon nanotubes can be purified by a centrifugal separation method. It is to be understood that the adhesive layer can, opportunely be disposed on two opposite surfaces of the base so as to form a double-sided adhesive tapes.

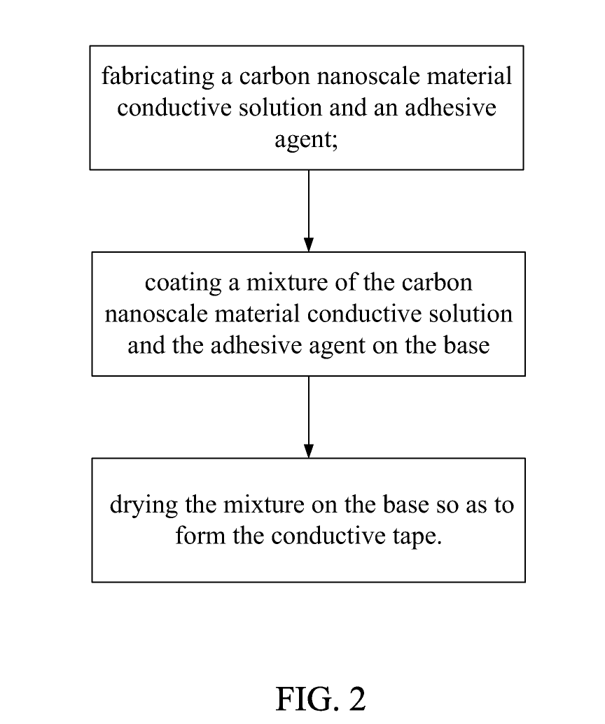

Referring to FIG. 2, a method for making a conductive tape 10 is provided in the present embodiment. The method includes the steps of: (a) fabricating a carbon nanoscale material conductive solution and an adhesive agent; (b) coating with a mixture of the carbon nanoscale material conductive solution and the adhesive agent on the base; and (c) drying the mixture on the base so as to form the conductive tape.

In step (a), the nanoscale material conductive solution can, advantageously be formed by the steps of: (a1) mixing the carbon nanoscale material with dichloroethane so as to obtain a dispersion solution of carbon nanoscale material and dichloroethane; and (a2) adding an organic carrier in the dispersion solution, thereby forming the carbon nanoscale material conductive solution.

In step (a1), the nanoscale material is nanoscale particles. The nanoscale particles can, beneficially, be carbon nanotubes, carbon nanoscale particles, and any combinations thereof. In the present embodiment, the carbon nanoscale material is two grams of carbon nanotubes. A volume of the dichloroethane is about 400 milliliters. A cell breaking machine is used for 15 minutes, then an ultrasonic vibrating machine is used for 30 minutes to obtain the dispersion solution.

Further, in step (a1), to filter out some agglomerated clusters in the dispersion solution, a process of filtration can, opportunely be incorporated. Specifically, a filter screen is used to execute the step of filtration. The filter screen is selected according to practical needs. In the present embodiment, a 400 meshes filter screen is used.

In step (a2), about 30 grams of the organic carrier are added to the dispersion solution in the present embodiment. The organic carrier includes 5 grams of ethylcellulose, 5 milliliters of dibutyl phthalate, and 90 milliliters of terpineol. After the organic carrier is added to the dispersion solution, a cell breaking machine is used for 15 minutes and an ultrasonic vibrating machine is used for 30 minutes on the dispersion solution, thereby forming the nanoscale material conductive solution. The parameters of the step (a2) can beneficially selected according to practical needs. Understandably, the organic carrier can opportunely enhance adhesive property of the carbon nanoscale material conductive solution.

In step (a), a method for making the adhesive agent is provided in the present embodiment. Specifically, butyl acrylate, 2-ethylhexyl acrylate, vinyl acetate, glycidyl methacrylate, acrylic acid, benzoyl peroxide, toluene and ethyl acetate are mixed and uniformly dispersed, thereby forming the adhesive agent. Quite suitably, mass ratios of the above-described substances are 112.5:116.5:12.5:1.25:7.5:0.5:87.5:162.5 in that order. A process of dispersing is selected from the group consisting of a cell breaking method and an ultrasonic vibrating method. Further, due to high cohesion and bonding strength of the adhesive agent, it can be applied to fabricate adhesive tapes, self-adhesive labels, double-sided adhesive tapes, and other adhesive products. When the adhesive agent is used for double-sided adhesive tapes, its adhesive strength is up to 5.6 N/cm. Understandably, the mass percentages of the above-described substances can, advantageously, be selected according to practical needs.

In step (b), a process of coating the mixture of carbon nanoscale material conductive solution and the adhesive agent on the base the substeps of: (b1) mixing and dispersing the carbon nanoscale conductive solution and the adhesive agent to obtain the mixture; (b2) evaporating the mixture so as to remove a solvent; and (b3) coating the base with the evaporated mixture.

In step (b1), the process of dispersing is accomplished by using a cell breaking machine for 15 minutes, and an ultrasonic vibrating machine for 30 minutes. In step (b2), the mixture is put in a water bath with a temperature of 100° C. and continuously agitated. Preferably, a muddler is used in the embodiment. In step (c), a process of drying includes air-drying, heat-drying, or a combination thereof. It is to be noted that after the adhesive agent in the mixture has dried it forms the adhesive layer 104.

The conductive tape in the present embodiment has the carbon nanoscale material in the adhesive layer 104. Because electrical conductivity of the carbon nanoscale material, especially the carbon nanotubes, is better than that of amorphous carbon, the electrical resistance of the present conductive tape is lower than that of the conventional conductive tape containing the amorphous carbon. Moreover, the method in the present embodiments employs relatively little carbon nanoscale material to obtain the same electrical conductivity of CCT. Thus, the method for making the conductive tape 10 has a low production cost. It is to be noted that the conductive tape 10 in the present embodiment can, opportunely be used as an antistatic packaging material.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention

What is claimed is:

1. A conductive tape comprising:
a base; and
an adhesive layer comprising a carbon nanoscale material and formed on a surface of the base.

2. The conductive tape as claimed in claim 1, wherein the carbon nanoscale material is composed of nanoscale particles.

3. The conductive tape as claimed in claim 1, wherein the nanoscale particles are selected from the group consisting of carbon nanotubes and carbon nanoscale spheres.

4. The conductive tape as claimed in claim 3, wherein the carbon nanotubes is selected from the group consisting of single-walled carbon nanotubes and multi-walled carbon nanotubes.

5. A method for making a conductive tape, the method comprising the steps of:
(a) fabricating a carbon nanoscale material conductive solution and an adhesive agent;
(b) coating a mixture of the carbon nanoscale material conductive solution and the adhesive agent on the base; and
(c) drying the mixture on the base so as to form the conductive tape.

6. The method as claimed in claim 5, wherein in step (a), the process of fabricating the adhesive agent comprises the steps of mixing butyl acrylate, 2-ethylhexyl acrylate, vinyl acetate, glycidyl methacrylate, acrylic acid, benzoyl peroxide, toluene and ethyl acetate.

7. The method as claimed in claim 5, wherein in step (a), the process of fabricating the nanoscale material conductive solution includes the substeps of: (a1) mixing the carbon nanoscale material with dichloroethane so as to obtain a dispersion solution of carbon nanoscale material and dichloroethane; and (a2) adding an organic carrier to the dispersion solution, thereby forming the carbon nanoscale material conductive solution.

8. The method as claimed in claim 7, wherein in step (a1), a cell breaking machine and then an ultrasonic vibrating machine is used to obtain the dispersion solution.

9. The method as claimed in claim 7 wherein in step (a2), the organic carrier is selected form the group consisting of ethylcellulose, dibutyl phthalate, and terpineol.
